(19) United States
(12) Patent Application Publication
(10) Pub. No.: US 2026/0054281 A1
(43) Pub. Date: Feb. 26, 2026

(54) SPRAY COATING APPARATUS

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/306,624

(22) Filed: Aug. 21, 2025

(30) Foreign Application Priority Data
Aug. 23, 2024 (CN) 2024220635497
Aug. 4, 2025 (CN) 2025216479611

(51) Int. Cl. B05B 9/043; B05B 12/08; B05B 15/40

(52) U.S. Cl. CPC B05B 9/043; B05B 12/08; B05B 15/40

(57) ABSTRACT

A spray coating apparatus includes a tank, spray gun, pump, and base, the pump having an inlet and outlet, the tank detachably mounted on the base, the pump disposed in the base; a switching valve at the bottom of the tank, a communication structure communicating the switching valve with the inlet on the base; the tank, when being mounted on the base, actuates the switching valve to switch from closed to open, and when detached from the base, actuates the switching valve to switch from open to closed. If residual coating material remains in the tank after coating, the tank may be removed to empty the residual material or transfer it back to an external container. In addition, due to detachable setting of the tank, it is only needed to replace the worn tank alone, so that replacement cost may be reduced.

### CROSS-REFERENCE TO RELATED APPLICATION(S)

This application claims priority to Chinese Application No. 202422063549.7 filed with China National Intellectual Property Administration on Aug. 23, 2024, the disclosures of which are incorporated herein by reference in their entities.

### FIELD

The subject matter described herein relates to spray coating equipment, and more particularly relates to a spray coating apparatus.

### BACKGROUND

An existing spray coating apparatus comprises a feed device, a spray gun, and an atomizer. A coating material in the feed device is pressurized and pumped to the spray gun, and at a spray nozzle of the spray gun, the pressurized coating material is released and instantaneously atomized and sprayed out to a surface of a workpiece, whereby a coating layer is applied. The spray coating apparatus is applicable to sectors such as furniture manufacturing, building and construction, and automobile manufacturing.

Spray coating apparatuses may be categorized into handheld types and stationary types. The handheld spray coating apparatus has a smaller tank and is thusly light-weighted so that a user may hold the apparatus by hand. The stationary spray coating apparatus has a larger tank which can hold more coating material and is thusly heavy-weighted; a spray gun is connected to a high-pressure pump port via a hose so that a user can hold the spray gun to perform spray coating, which facilitates the user's operation. In an existing stationary spray coating apparatus, the tank is generally fixedly secured on a base; the user first estimates an amount of coating material based on the area to be coated and then loads the coating material into the tank. If excess coating material is loaded and residual coating material remains after coating, it is needed to empty the residual coating material from the tank back into an external container. Since the tank is fixedly secured on the base so that the overall equipment is heavy, and particularly when more coating material is left in the tank, it would be laborious to empty the coating material back into the external container, which would compromise user experience. In addition, since the tank is fixedly secured on the base, when the tank is worn out, it needs to replace the entire equipment, which incurs a higher cost.

### SUMMARY

To overcome the drawbacks and disadvantages in conventional technologies noted supra, the present disclosure provides a spray coating apparatus, in which a tank is detachably mounted on a base so as to facilitate operation and reduce replacement cost.

A spray coating apparatus according to the present disclosure comprises:
a tank in which a coating material is held;
a spray gun which atomizes and sprays out the coating material pressurized;
and a pump which pressurizes and pumps the coating material from the tank to the spray gun, the pump having an inlet and an outlet;
wherein the spray coating apparatus further comprises a base on which the tank is detachably mounted, the pump being disposed in the base, a switching valve being provided at an underside of the tank; a communication structure operable to communicate the switching valve with the inlet is provided on the base; the tank, when being mounted on the base, actuates the switching valve to switch from a closed state to an open state, and when being detached from the base, actuates the switching valve to switch from the open state to the closed state.

In some implementations, the switching valve comprises a valve seat, a valve disk, and an elastic member, a valve bore being set on the valve seat, the valve disk being movably disposed on the valve seat and operable to open and close the valve bore, the elastic member biasing the valve disk in a direction of closing the valve bore.

In some implementations, the communication structure comprises a communication passage in which an ejector rod corresponding to the switching valve is provided; and the tank, when being mounted on the base, drives the valve disk to engage the ejector rod so that the valve disk overcomes a bias imposed by the elastic member to open the valve bore.

In some implementations, a filter mounted detachably is provided in the communication passage, a plurality of filter holes distributed at even intervals being set on the filter, the ejector rod being disposed on the filter.

In some implementations, the switching valve is disposed on a bottom wall of the tank, the bottom wall of the tank extending obliquely downward from a position distant from the switching valve toward a position where the switching valve is located.

In some implementations, a local top wall of the base under the tank extends obliquely downward from a position distant from the communication structure to a position where the communication structure is located, a slope of the local top wall of the base being greater than a slope of the bottom wall of the tank.

In some implementations, the underside of the tank is provided with a support leg protruding downward, an underside of the support leg being lower than an underside of the switching valve, a locating hole for the support leg to insert being provided on the base; and/or, a locking fastener for securing the tank is provided on the base, and a catch block or catch recess fitted with the locking fastener is provided on the tank.

In some implementations, the pump comprises an electric motor, a pump body, and a transmission structure, the pump body being transversely rested in the base, a central axis of the pump body being disposed lower than the bottom wall of the tank.

In some implementations, the base comprises a bottom casing, a top casing, and a cover, the top casing and the cover being secured side by side on the bottom casing, the tank being detachably mounted on top of the top casing, the cover and the bottom casing being fitted to define a mounting cavity in which the pump is disposed.

In some implementations, the cover has a storage cavity downwardly recessed.

In some implementations, the pump is further provided with a drainage port, a return line being attached at the drainage port; and the return line drains the coating material flowing out via the drainage port into the tank or the communication structure.

In some implementations, the return line drains the coating material flowing out from the drainage port into the tank, one end of the return line communicating with the drainage port, another end of the return line being provided with a first return connector, the first return connector being fixedly secured on the base or detachably secured on the base; a second return connector detachably fitted with the first return connector is provided on the tank; the tank, when being mounted on the base, drives the second return connector to be plug-fitted with the first return connector, whereby the another end of the return line communicates with an inside of the tank; and the tank, when being detached from the base, drives the second return connector to be separated from the first return connector.

In some implementations, the return line drains the coating material flowing out from the drainage port into the communication structure, the return line being disposed on the base, one end of the return line communicating with the drainage port, another end of the return line communicating with the communication structure.

With the technical solutions noted supra, the present disclosure offers the following benefits:
1. In the spray coating apparatus according to the present disclosure, the tank is detachably mounted on the base, and the switching valve is provided at the underside of the tank. The switching valve is in the closed state when the tank is detached from the base, preventing the coating material in the tank from flowing out or leaking. When the tank is mounted on the base, the switching valve is switched from the closed state to the open state, so that the coating material in the tank, pumped by the pump, may be smoothly fed to the spray gun, whereby the apparatus may operate normally. Since the tank is detachably mounted on the base, if residual coating material remains in the tank after coating, the tank can be removed from the base to empty the residual coating material or transfer it back into an external container, which may facilitate the user's operations on emptying the coating material or transferring it back into the external container. In addition, due to the detachable setting, it is only needed to replace the worn-out tank, which may reduce the replacement cost. Furthermore, due to the detachable setting, two or more tanks holding different coating materials may be equipped to the apparatus, so that the user may change a tank holding a different coating material dependent on coating needs, without a bother to empty the coating material from the current tank for re-filling with the desired coating material, whereby coating efficiency can be enhanced.
2. The switching valve comprises a valve seat, a valve disk, and an elastic member; a valve bore is formed on the valve seat; the elastic member biases the valve disk in a direction of closing the valve bore. By reasonably setting the specific structure of the switching valve, the switching valve is in the normally closed state, which also facilitates the switching valve to switch from the closed state to the open state.
3. An ejector rod is disposed in the communication passage; when the tank is mounted on the base, the ejector rod engages the valve disk driving the latter to overcome the bias imposed by the elastic member to move in a direction of opening the valve bore, whereby the valve bore is opened so that the coating material in the tank may flow toward the pump via the communication passage. By reasonably setting the communication structure, when the tank is mounted on the base, the switching valve may smoothly switch from the closed state to the open state.
4. A detachable filter is provided in the communication passage, and a plurality of filter holes distributed at even intervals are provided on the filter; by employing a filter to remove impurities in the coating material flowing towards the pump via the communication structure, the impurities would not get into the pump so that no clogging would occur. Since the filter is detachably provided in the communication passage, it is easy to take out the filter for cleaning upon completion of the operation. By disposing the ejector rod on the filter so that the ejector rod and the filter are integrated into one piece, the number of components may be reduced appropriately, which also facilitates setting of the ejector rod.
5. The switching valve is disposed on the bottom wall of the tank, and the bottom wall of the tank extends obliquely downward from a position distant from the switching valve to a position where the switching valve is located. By reasonably setting the specific structure of the tank, the coating material in the tank may flow out via the switching valve during operation of the apparatus, which prevents waste of the coating material.
6. A local top wall of the base under the tank is oriented obliquely; a slop of the local top wall of the base is greater than that of the bottom wall of the tank; when excess coating material is held, the bottom wall of the tank would be bulged downward and deformed; the oblique top wall of the base avoids the oblique bottom wall of the tank, so that the tank can be smoothly mounted on the base.
7. A support leg protruding downward is provided at the underside of the tank, the underside of the support leg being lower than the underside of the switching valve; when the tank is placed separately on the ground surface, the support leg engages the ground surface, which may prevent the switching valve from contacting the ground surface, thereby preventing the switching valve from being accidentally opened, which also prevents the switching valve from being stressed and damaged. Locating holes for the supporting legs to insert are provided on the base; when the tank is mounted on the base, the support legs are inserted in the locating holes to retain the tank, which may enhance mounting stability of the tank on the base.

A locking fastener is provided on the base, and a catch block or a catch recess is provided on the tank; fitting between the locking fastener and the catch block/recess locks the tank so that the tank is securely mounted on the base, preventing the tank from vibrating or being displaced relative to the base when the apparatus is operating.
8. The pump comprises an electric motor, a pump body, and a transmission structure, the pump body being transversely rested in the base, a central axis of the pump body being exemplarily disposed lower than the bottom wall of the tank, i.e., the pump body being disposed lower than the tank. By reasonably setting the positional relationship between the pump body and the tank in terms of height, the coating material in the tank, pumped by the pump, flows under its self-weight faster towards the pump via the communication structure.
9. The base comprises a bottom casing, a top casing, and a cover, the top casing and the cover being secured side by side on the bottom casing, the tank being detachably mounted on the top portion of the top casing, the cover and the bottom casing being fitted to define a mounting cavity in which the pump is disposed. By reasonably setting a specific structure of the base, components such as the tank and the pump are arranged reasonably, resulting in a more compact overall structure.
10. The cover has a storage cavity downwardly recessed; components such as the spray gun and the hose may be stored in the storage cavity when the apparatus is in the idle state, which may prevent the components such as the spray gun and the hose from being bumped by other objects.

### BRIEF DESCRIPTION OF THE DRAWINGS

FIG. 1 is an overall structural view of a spray coating apparatus according to a first implementation of the present disclosure;

FIG. 2 is a structural diagram of the spray coating apparatus with a tank detached from a base in the first implementation of the present disclosure;

FIG. 3 is a structural diagram of the tank of the spray coating apparatus in the first implementation of the present disclosure;

FIG. 4 is a left-right sectional view of the tank of the spray coating apparatus in the first implementation of the present disclosure;

FIG. 5 is an enlarged view of part A in FIG. 4;

FIG. 6 is an exploded view of a switching valve in the spray coating apparatus in the first implementation of the present disclosure;

FIG. 7 is a local exploded view of the switching valve and the tank in the spray coating apparatus in the first implementation of the present disclosure;

FIG. 8 is an exploded view of the base in the spray coating apparatus in the first implementation of the present disclosure;

FIG. 9 is a structural view of a top casing in the spray coating apparatus in the first implementation of the present disclosure;

FIG. 10 is a front-rear sectional view of the top casing in the spray coating apparatus in the first implementation of the present disclosure;

FIG. 11 is a structural view of the spray coating apparatus with a pump being mounted in the base in the first implementation of the present disclosure;

FIG. 12 is a structural view of a pump body in the spray coating apparatus in the first implementation of the present disclosure;

FIG. 13 is a structural view of a base in a spray coating apparatus in a second implementation of the present disclosure;

FIG. 14 is an exploded view of a pump body and a return line in the second implementation of the present disclosure;

FIG. 15 is a structural view of a tank in the second implementation of the present disclosure;

FIG. 16 is a local sectional view of the return line and the tank when a first return connector is plug-in fitted with a second return connector in the second implementation of the present disclosure;

FIG. 17 is a partial structural view of a base in a third implementation of the present disclosure;

FIG. 18 is an exploded view of a pump body and a return line in the third implementation of the present disclosure;

FIG. 19 is a front-rear sectional view of a top casing in the third implementation of the present disclosure.

In the drawings: 100—tank; 110—tank body; 111—sidewall; 112—bottom wall; 113—mounting port; 114—support leg; 115—second hollow column; 116—second return connector; 120—lid; 130—catch block; 140—catch recess;

210—spray gun; 220—hose; 230—second connector;

300—pump; 301—inlet; 302—outlet; 310—electric motor; 320—pump body; 321—feed line; 322—discharge line; 323—pressure relief line; 3231—first hollow column; 324—drainage port; 330—transmission structure; 340—first connector; 350—rotary knob;

400—switching valve; 410—valve seat; 411—valve bore; 412—seat ring; 413—support bar; 414—ejector block; 415—flange; 420—valve disk; 430—elastic member; 440—sealing ring;

500—base; 510—communication structure; 511—communication passage; 511a—stepped surface; 512—ejector rod; 513—filter; 514—filter hole; 520—bottom casing; 521—recessed cavity; 522—clearance hole; 530—top casing; 531—vertical plate; 532—locating surface; 533—locating hole; 534—tubular shell; 535—third hollow column; 540—cover; 550—locking fastener; 560—storage cavity; 570—return line; 580—clamp; 590—first return connector.

### DETAILED DESCRIPTION OF EMBODIMENTS

Hereinafter, the present disclosure will be further illustrated through example implementations with reference to the accompanying drawings. It would be understood that the orientational or positional relationships indicated by the terms “upper,” “lower,” “left,” “right,” “longitudinal,” “transverse,” “inner,” “outer,”“vertical,” “horizontal,” “top,” “bottom,” and etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms shall not be construed as limitations to the disclosure.

### First Implementation

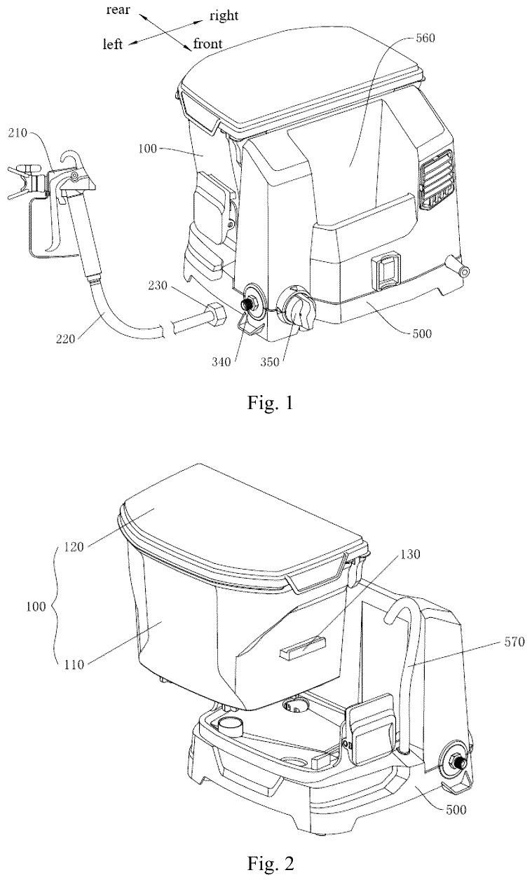

Referring to FIGS. 1 to 12, a spray coating apparatus according to a first implementation of the present disclosure comprises:
a tank 100 in which a coating material is held;
a spray gun 210 which atomizes and sprays out the coating material pressurized;
a pump 300 which pressurizes and pumps the coating material in the tank 100 to the spray gun 210, the pump 300 having an inlet 301 and an outlet 302;
a base 500 on which the tank 100 is detachably mounted, the pump 300 being disposed in the base 500, an underside of the tank 100 being provided with a switching valve 400, a communication structure 510 operable to communicate the switching valve 400 with the inlet 301 being provided on the base 500; and the tank 100, when being mounted on the base 500, actuates the switching valve 400 to switch from a closed state to an open state, and when being detached from the base 500, actuates the switching valve 400 to switch from the open state to the closed state.

Since the tank 100 is detachably mounted on the base 500, in a case that residual coating material remains in the tank 100 after coating, the tank 100 may be removed from the base 100 so as to empty the residual coating material or transfer it back into an external container; this arrangement may facilitate a user's operation on emptying the residual coating material or transferring it back into the external container. In addition, due to the detachable setting of the tank 100, in a case that the tank 100 is damaged, it is only needed to replace the tank 100 alone, which may lower the replacement cost. Furthermore, due to the detachable setting of the tank 100, the apparatus may be equipped with two or more tanks 100 that hold different coating materials, so that the user may change a tank 100 holding a desired coating material dependent on coating needs, without being bothered by emptying the residual coating material in the tank 100 for re-filling with the desired coating material, thereby enhancing coating efficiency.

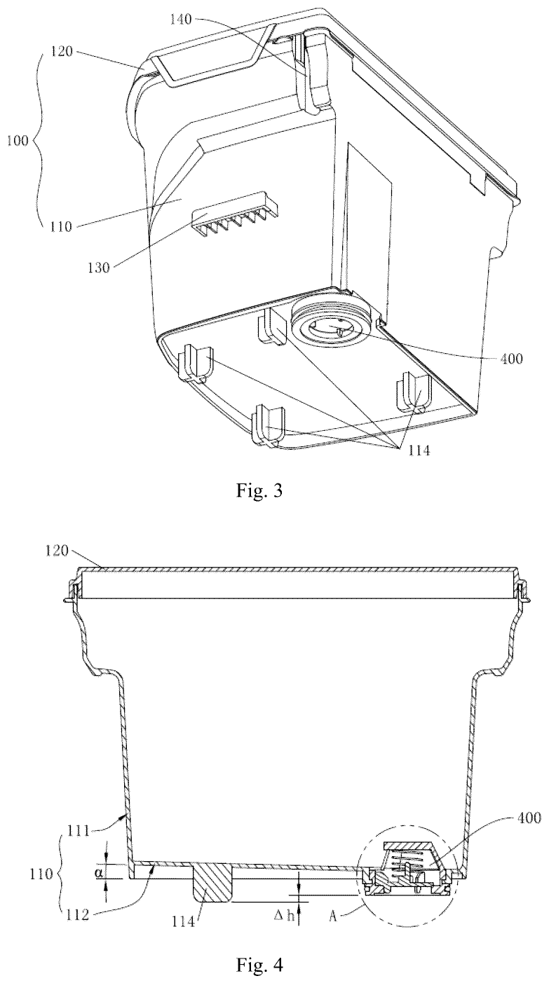

Referring to FIGS. 2 and 3, in this implementation, the tank 100 comprises a tank body 110 and a lid 120, a top side of the tank body 110 being open, the lid 120 being operable to open and close the top side of the tank body 110. As an optional solution of this implementation, the lid 120 may be hinged to the top side of the tank body 110 and secured to the lid 120 via a fastening structure; the lid 120 may also be detachably provided relative to the tank body 110 and secured to the lid 120 via the fastening structure.

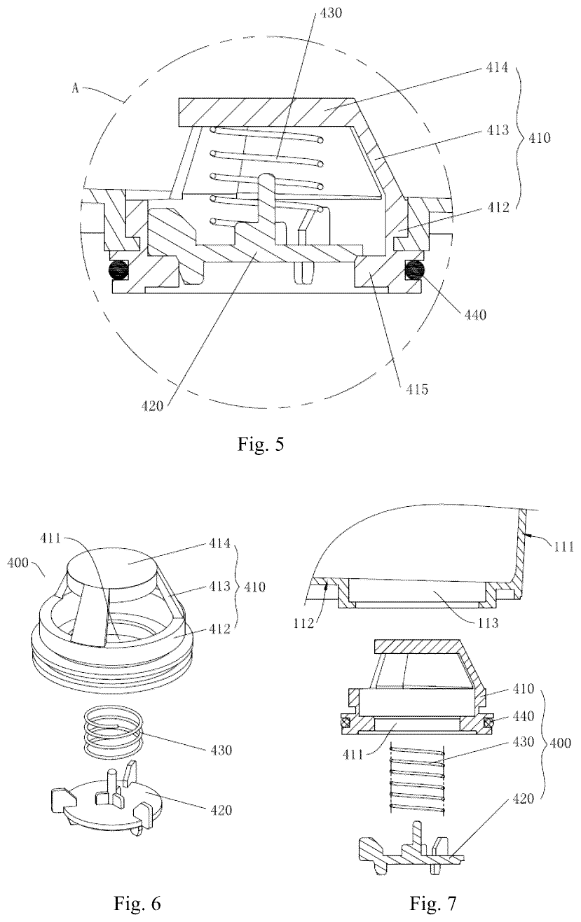

Referring to FIG. 4, the tank body 110 of the tank 100 comprises a circle of sidewall 111 and a bottom wall 112 disposed at a lower end of the sidewall 111, the switching valve 400 being exemplarily disposed on the bottom wall 112 of the tank body 110. Referring to FIGS. 5, 6, and 7, a mounting port 113 is formed on the bottom wall 112 of the tank body 110, the switching valve 400 being attached at the mounting port 113. Specifically, the switching valve 400 comprises a valve seat 410, a valve disk 420, and an elastic member 430, a valve bore 411 being formed on the valve seat 410, the valve disk 420 being movably disposed on the valve seat 410 and operable to open and close the valve bore 411, the elastic member 430 biasing the valve disk 420 in a direction of closing the valve bore 411. Furthermore, the valve seat 410 comprises a seat ring 412 fitted with the mounting port 113 and an ejector block 414 mounted above the seat ring 412 via a support bar 413, the valve bore 411 being enclosed by the seat ring 412, two or three support bars 413 being provided at intervals in the circumferential direction of the seat ring 412, the ejector block 414 being disposed higher than the seat ring 412. A sealing ring 440 is sleaved over an outer periphery of the seat ring 412, the seat ring 412 being axially retained at the mounting port 113, the sealing ring 440 enabling circumferential sealing fit between the seat ring 412 and the mounting port 113. A circle of flange 415 is provided on an inner peripheral surface of the seat ring 412; the valve disk 420 is disposed between the flange 415 and the ejector block 414; a top end of the elastic member 430 abuts against the ejector block 414 to realize positional retainment, and a bottom end of the elastic member 430 abuts against the valve disk 420 to realize engagement with the valve disk 420; the elastic member 430 is thusly compressed to bias the valve disk 420 downward; the valve disk 420 is biased by the elastic member 430 to abut against the flange 415 to thereby close the valve bore 411, preventing the coating material in the tank 100 from flowing out via the valve bore 411. When the valve disk 420 is stressed to overcome the bias imposed by the elastic member 430 to move upward, the valve disk 420 migrates from the flange 415 to open the valve bore 411, so that the coating material in the tank 100 may flow out via the valve bore 411; the elastic member 430 is further compressed when the valve disk 420 opens the valve bore 411. As an optional solution of this implementation, the elastic member 430 may adopt an elastic member such as a spring. Of course, a detailed structure of the switching valve 400 is not limited to the description supra, and any switching valve 400 is allowed so long as it is closed when the tank 100 is detached from the base 500 and opened when the tank 100 is mounted on the base 500.

To allow for the coating material in the tank 100 to flow out smoothly via the valve bore 411 of the switching valve 400, as an example of this implementation, the bottom wall 112 of the tank 100 extends obliquely downward from a position distant from the switching valve 400 towards the position where the switching valve 400 is located; as such, the switching valve 400 is disposed at a lowest part of the bottom wall 112, whereby the coating material in the tank 100 may flow, under its own weight, towards the switching valve 400, and the coating material in the tank 100 may be drained as much as possible via the valve bore 411 of the switching valve 400. For example, when the switching valve 400 is disposed at a left front corner of the bottom wall 112, the bottom wall 112 of the tank body 110 may extend obliquely downward from right to left or extend obliquely downward from rear to front; in any of these cases, the coating material may flow toward the position where the switching valve 400 is located. Of course, the switching valve 400 may also be disposed at another position of the bottom wall 112; correspondingly the bottom wall 112 of the tank body 110 extends obliquely downward from a position distant from the switching valve 400 towards the position where the switching valve 400 is located. As an optional solution of this implementation, an inclination angle α of the bottom wall 112 shall not be set too large or too small, which may be set to a reasonable value such as 1°, 1.5°, 2°, 2.5°, 3°, 3.5°, 4°, 4.5°, and 5°.

The switching valve 400 protrudes downward relative to the bottom wall 112 of the tank body 110; to allow for the tank 100 to be stably rested on the ground surface, a plurality of support legs 114 protruding downward are provided at the bottom wall 112 of the tank body 110; the undersides of respective support legs 114 are substantially flush with each other and may be combined into a plane; the undersides of the support legs 114 are exemplarily disposed lower than the underside of the switching valve 400. When the tank 100 is rested on the ground surface, the undersides of respective support legs 114 contact the ground surface, in which case the underside of the switching valve 400 is slightly higher than the ground surface to prevent the switching valve 400 from being stressed and damaged. As an optional solution of this implementation, the transverse sectional profile of the support leg 114 may be set to a reasonable shape such as a cross shape, a T shape, a round shape, a rectangular shape, a triangular shape, or a circular ring shape; the support legs 114 may be distributed at various corners of the bottom wall 112 or distributed in another pattern. This implementation does not limit the shape and distribution pattern of the support legs 114. A height difference 4 h between the undersides of the support legs 114 and the underside of the switching valve 400 may be set to any value ranging from 2 mm to 20 mm.

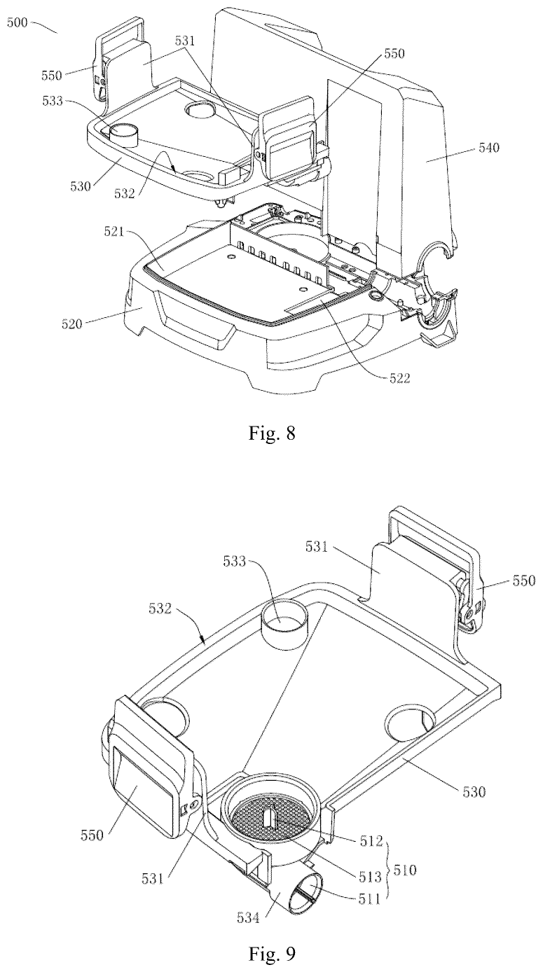

Referring to FIG. 8, in this implementation, the base 500 comprises a bottom casing 520, a top casing 530, and a cover 540, the top casing 530 and the cover 540 being arranged in a front-rear side-by-side manner and secured on the bottom casing 520, the tank 100 being detachably mounted on top of the top casing 530, the cover 540 being fitted with the bottom casing 520 to define a mounting cavity, the pump 300 being disposed in the mounting cavity. Specifically, the bottom casing 520 is set with an increasing height from front to rear, the top casing 530 being secured to a top side of a rear portion of the bottom casing 520, the cover 540 being secured to a top side of a front portion of the bottom casing 520.

To maintain structural stability of the tank 100 when the apparatus is operating, a locking fastener 550 configurable to secure the tank 100 is provided on the base 500, and a catch block 130 or a catch recess fitted with the locking fastener 550 is provided on the tank 100. Specifically, vertical plates 531 extending upward and arranged oppositely are provided at left and right sides of the top casing 530, and a rotatable locking fastener 550 is provided at a top side of each of the two vertical plates 531. A catch block 130 protruding outward is provided on each of the left and right sidewalls 111 of the tank body 110 of the tank 100. The tank 100 is mounted on the base 500 by turning the locking fasteners 550 to fit with the catch blocks 130, which secures the tank 100 on the base 500. The tank 100 is removed by turning the locking fasteners 550 to release the catch blocks 130, whereby the locking fasteners 550 are disengaged from the catch blocks 130. As an alterative solution of this implementation, a catch recess may be adopted to replace the catch block 130. In this case, a bump fitted with the catch recess is provided on the locking fastener 550; when the locking fastener 550 is fitted with the catch recess, the bump is inserted in the catch recess. As an example solution of this implementation, the locking fastener 550 or the catch recess is disposed substantially in the middle of the tank 100 in terms of height. A specific structure of the locking fastener 550 may refer to any structure satisfying requirements of securing the tank 100 in conventional technologies, which is not limited here.

A circle of locating surface 532 is provided at an outer periphery of the top side of the top casing 530, and locating holes 533 corresponding to respective support legs 114 for the latter to insert are provided on the top casing 530. The communication structure 510 is disposed directly below the switching valve 400; since the bottom wall 112 of the tank 100 is inclinedly disposed and the bottom wall 112 of the tank 100 would be bulged and deformed downward due to the coating material loaded, a portion of the top casing 530 located at the inner periphery of the locating surface 532 extends obliquely downward from a position distant from the communication structure 510 towards a position where the communication structure 510 is located, i.e., a local top wall of the base 500 under the tank 100 extends obliquely downward from the position distant from the communication structure 510 towards the position where the communication structure 510 is located, allowing for the tank 100 to be smoothly mounted on the base 500; the slope of the inclined portion of the top casing 530 is exemplarily slightly greater than a slope of the bottom wall 112 on the tank 100, i.e., an inclination angle β of the inclined portion in the top casing 530 is slightly greater than an inclination angle α of the bottom wall 112 of the tank body 110, e.g., the inclination angle β may be set to a reasonable value such as 7°, 8°, 9°, 10°, 11°, and 12°.

The bottom casing 520 is provided with a recessed cavity 521 under the top casing 530; when the tank 100 is mounted on the base 500, the support legs 114 pass through the locating holes 533 on the top casing 530; in this way, vertical support of the tank 100 may be implemented via engagement between the underside of the tank 100 and the locating surface 532 or via engagement between the undersides of the support legs 114 and the inner bottom wall of the recessed cavity 521.

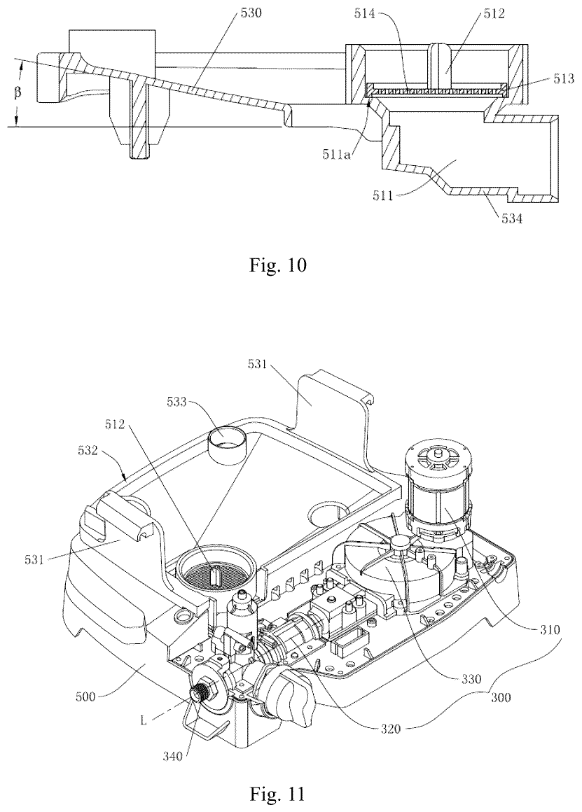

Referring to FIGS. 9 and 10, the communication structure 510 comprises a communication passage 511, one end of the communication passage 511 being oriented to face upward to correspond to the switching valve 400, another end thereof being oriented to face the pump 300 and communicate with the inlet 301 of the pump 300. Specifically, a hollow tubular shell 534 is provided at a position of the top casing 530 corresponding to the switching valve 400, a hollow inner cavity of the tubular shell 534 constituting the communication passage 511, a clearance hole 522 configurable to avoid the tubular shell 534 being provided on the bottom casing 520. As an optional solution of this implementation, the tubular shell 534 may be integrally formed with the top casing 530; the tubular shell 534 may also be formed separately and then secured on the top casing 530 via a fastener.

To allow for the switching valve 400 to be smoothly opened when the tank 100 is mounted on the base 500, an ejector rod 512 corresponding to the switching valve 400 is provided in the communication passage 511; when the tank 100 is mounted on the base 500, the valve disk 420 engages the ejector rod 512 so that the valve disk 420 overcomes the bias imposed by the elastic member 430 to move upward to open the valve bore 411. To prevent impurities in the coating material from entering the pump 300 causing cloggage, a detachably mounted filter 513 is further provided in the communication passage 511; and a plurality of filter holes 514 distributed at even intervals are provided on the filter 513, the ejector rod 512 being exemplarily disposed on the filter 513. Specifically, a horizontal stepped surface 511a is provided on an inner wall of one end of the communication passage 511 facing the switching valve 400, and the filter 513 mounted in the communication passage 511 engages the stepped surface 511a so as to be vertically supported. The ejector rod 512 protrudes upward relative to the filter 513; when the tank 100 is mounted on the base 500, the ejector rod 512 engages the valve disk 420 so that the valve disk 420 is stressed to overcome the bias imposed by the elastic member 430 to move upward, whereby the valve disk 420 opens the valve bore 411. When the tank 100 is detached from the base 500, the ejector rod 512 releases the valve disk 420, and the elastic member 430 recovered from deformation drives the valve disk 420 to move downward, whereby the valve disk 420 closes the valve bore 411. As an optional solution of this implementation, the ejector rod 512 and the filter 513 may be integrally formed; or, the ejector rod 512 may be separately formed and then secured on the filter 513.

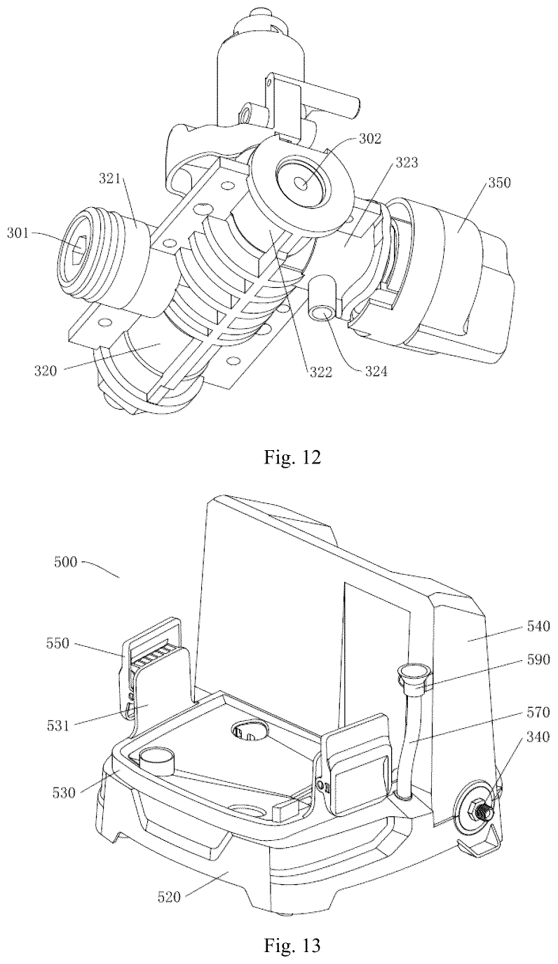

Referring to FIG. 11, the pump 300 comprises an electric motor 310, a pump body 320, and a transmission structure 330, the inlet 301 and the outlet 302 being arranged on the pump body 320. The pump body 320, the transmission structure 330, and the electric motor 310 are arrayed sequentially from left to right. The electric motor 310 is exemplarily vertically oriented in the axial direction, the pump body 320 is exemplarily horizontally oriented in the axial direction, and the transmission structure 330 converts a rotating movement of the electric motor 310 into a back-and-forth movement of the piston. Referring to FIG. 12, the pump body 320 is provided with a feed line 321 and a discharge line 322, the inlet 301 being disposed on the feed line 321, the outlet 302 being disposed on the discharge line 322. One end of the tubular shell 534 facing the pump body 320 is sleeved outside the feed line 321 to thereby communicate the communication passage 511 with the inlet 301. A one-way valve is provided in the feed line 321 and the discharge line 322, respectively. When the electric motor 310 actuates, via the transmission structure 330, the pump body 320 to draw in the coating material, the one-way valve in the feed line 321 is opened, while the one-way valve in the discharge line 322 is in a closed state. When the electric motor 310 actuates, via the transmission structure 330, the pump body 320 to pump out the coating material, the one-way valve in the feed line 321 is closed, while the one-way valve in the discharge line 322 is in an open state. The pump 300 in this implementation may adopt a single-plunger pump, a double-plunger pump, a three-plunger pump, or a diaphragm pump, etc., so long as it can pump out the coating material; a specific structure of the pump 300 may refer to conventional technologies, which is not detailed here.

As an example solution of this implementation, the pump body 320 is further provided with a pressure relief line 323, a pressure relief valve being disposed in the pressure relief line 323. The pressure relief line 323 is provided with a drainage port 324, and a rotary knob 350 configurable to adjust a predetermined pressure relief value of the pressure relief valve is provided on a sidewall 111 of the base 500. A return line 570 is provided on the base 500, one end of the return line 570 communicating with the drainage port 324, another end thereof being detachably secured on the top side of the tank body 110; a catch recess 140 for the return line 570 to snap in is provided on the sidewall 111 of the tank body 110. When the hydraulic pressure in the pump chamber of the pump body 320 is lower than the predetermined pressure relief value of the pressure relief valve, the pressure relief valve is closed so that the coating material in the pump chamber is drained via the outlet 302. When the hydraulic pressure in the pump chamber reaches the predetermined pressure relief value of the pressure relief valve, the pressure relief valve is switched to open, so that the coating material in the pump chamber may flow back into the tank 100 via the drainage port 324 and the return line 570, thereby preventing excess hydraulic pressure in the pump chamber that would otherwise cause damages to the pump body 320. A specific structure of the pressure relief valve may refer to conventional technologies, which is thusly not detailed here.

To enhance the coating material pumping effect of the pump 300, the central axis L of the pump body 320 is set exemplarily lower than the bottom wall 112 of the tank 100, i.e., the pump body 320 is disposed slightly lower than the tank 100. When the apparatus is operating, the coating material in the tank 100, which is pumped by the pump 300, flows faster under its self-weight via the communication structure 510 toward the pump 300.

The pump body 320 is provided with a first connector 340 sleeved outside the discharge line 322, the first connector 340 being exposed out of a side surface of the base 500. The spray gun 210 is connected to the pump 300 via a hose 220, one end of the hose 220 being fixedly connected or detachably connected to the spray gun 210, another end thereof being provided with a second connector 230 fitted with the first connector 340, the first connector 340 and the second connector 230 being detachably, securely connected via a thread-fitting structure or a twist-lock fitting structure. A discharge valve is provided in the spray gun 210, and a trigger operable to open and close the discharge valve is provided on the spray gun 210. The discharge valve is normally in a closed state; when the user presses the trigger, the discharge valve is switched to open, and the pressurized coating material flowing through the discharge valve is atomized and sprayed out via the spray nozzle at the front end of the spray gun 210 and applied to a surface of the workpiece. A specific structure of the spray gun 210 may refer to conventional technologies, which is not detailed here; of course, the spray gun 210 may adopt an automatically opened/closed pressure valve to replace the discharge valve and the trigger; when the coating material pressure reaches a preset value, the pressure valve is automatically opened so that the coating material is atomized and sprayed out via the spray nozzle.

The cover 540 has a storage cavity 560 downwardly recessed; when the apparatus is in an idle state, the accessories such as the spray gun 210 and the hose 220 may be stored in the storage cavity 560 so as to prevent the components such as the spray gun 210 and the hose 220 from being bumped by other objects.

To apply a coating material, the coating material is first loaded in the tank 100, and then the tank 100 is mounted on the base 500; or, the tank 100 is first mounted on the base 500 and then the coating material is loaded in the tank 100; the hose 220 is connected to the pump 300 via fitting between the second connector 230 and the first connector 340, which connects the spray gun 210 to the pump 300. When the tank 100 is mounted on the base 500, the switching valve 400 switches from the closed state to the open state. When the pump 300 is operating, the coating material in the tank 100, after being filtered by the filter 513, flows from the inlet 301 into the pump chamber of the pump body 320 along the communication passage 511, and the coating material flowing into the pump chamber is pressurized and then flows toward the spray gun 210 via the outlet 302 and the hose 220; when the user presses the trigger to open the discharge valve, the coating material is atomized and sprayed out via the spray nozzle at the front end of the spray gun 210 and applied to the surface of the workpiece. If residual coating material remains in the tank 100 after coating, the tank 100 is removed from the base 500 so as to empty the coating material or transfer it back into an external container.

The apparatus according to this implementation may also adopt a structure in which one base 500 is equipped with two or more tanks 100; in a case of applying a different coating material, the user may change a tank 100 loaded with the different coating material, which eliminates a need of emptying the residual coating material out of the current tank 100, whereby spraying efficiency can be enhanced.

After the coating is completed, water may be added to the tank 100, and the pump 300 is activated for self-cleaning, which keeps the tank 100, the communication structure 510, the pump 300 and the spray gun 210 clean, preventing clogging of the residual coating material that would otherwise degrade the coating effect.

As an example solution of this implementation, rolling wheels with a braking feature may be mounted at the bottom of the base 500 to facilitate movement of the entire apparatus.

The spray coating apparatus may adopt a stationary style or a back-mounted style. In a case of adopting the stationary style, the user may place the apparatus on the ground surface during operation. In a case of adopting the back-mounted style, the user may carry the apparatus by shoulders via a strap during operation. Of course, the spray coating apparatus may also be set switchable between the stationary style or the back-mounted style as needed; in this case, the apparatus is configured with a strap, two ends of which are connected to the base; the strap exemplarily adopts a detachable mounting structure so that the user may mount the strap as needed.

### Second Implementation

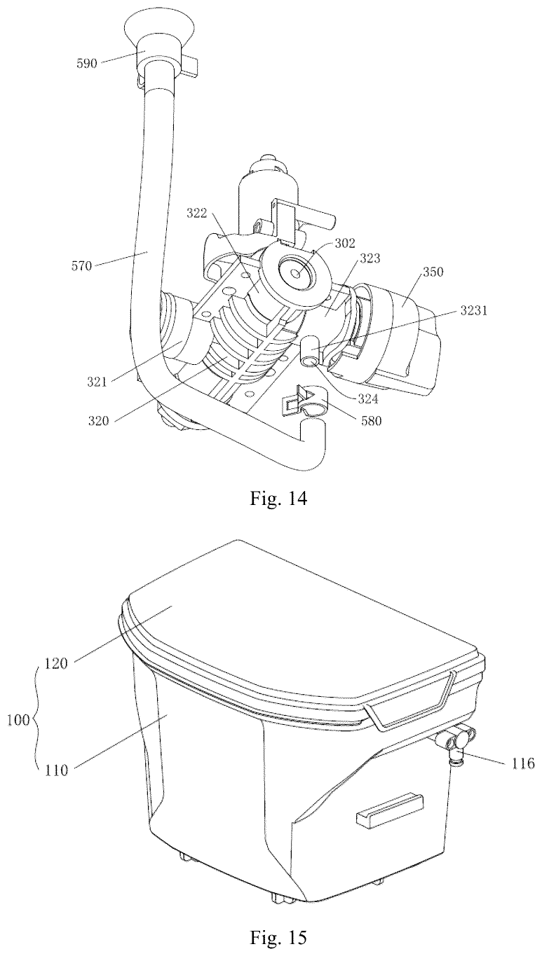

Referring to FIGS. 13, 14, and 15, in this implementation, the pressure relief line 323 is provided with a first hollow column 3231 protruding outward surrounding the drainage port 324, one end of the return line 570 being fixedly sleeved on the first hollow column 3231 via a clamp 580, the return line 570 passing through the base 500, another end of the return line 570 extending upward and being provided with a hollow first return connector 590. The first return connector 590 may be fixedly secured on the cover 540 of the base 500 via a fastener such as a screw or detachably secured on the cover 540 of the base 500 via a member such as a hook or a catch block. A second hollow column 115 protruding outward is provided on a sidewall of the tank body 110, holes on the second hollow column 115 communicating with the inside of the tank 100; the second hollow column 115 is fixedly sleeved with a hollow second return connector 116, while the second return connector 116 is detachably fitted with the first return connector 590.

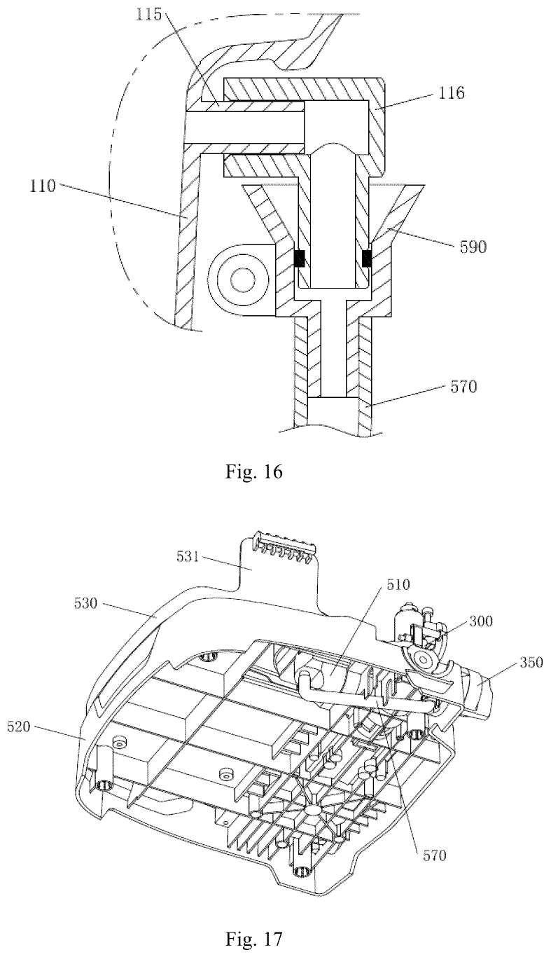

Referring to FIG. 16, when the tank 100 is mounted on the base 500, the second return connector 116 is plugged into the first return connector 590 to form a circumferentially sealed fit therebetween; an upper end of the return line 570 communicates with the inside of the tank 100 via plug-fitting between the first return connector 590 and the second return connector 116. When the hydraulic pressure in the pump chamber reaches a predetermined pressure relief value and the pressure relief valve is opened to release pressure, the coating material flowing out via the drainage port 324 flows back into the tank 100 via the return line 570.

When the tank 100 is removed from the base 500, the second return connector 116 is disengaged from the first return connector 590.

To facilitate plug-fitting between the second return connector 116 and the first return connector 590, an upper portion of the first return connector 590 may be set to a conical structure whose size is gradually shrunk from top to bottom.

To eliminate interference with mounting of the tank 100 on the base 500 as much as possible when the second return connector 116 is plug-fitted with the first return connector 590, the return line 570 and the drainage port 324 are exemplarily disposed at a same side relative to the base 500; moreover, the return line 570 and the first return connector 590 are set in a manner of avoiding the fitting area between the tank 100 and the cover 540.

To prevent the coating material in the tank 100 from flowing into the return line 570 via the second hollow column 115, the second hollow column 115 is disposed as high as possible relative to the tank body 110. Exemplarily, the second hollow column 115 may be disposed slightly higher than a maximum holding capacity scale of the tank 100.

The other contents of the second implementation are identical to those of the first implementation, which are thus not detailed here.

### Third Implementation

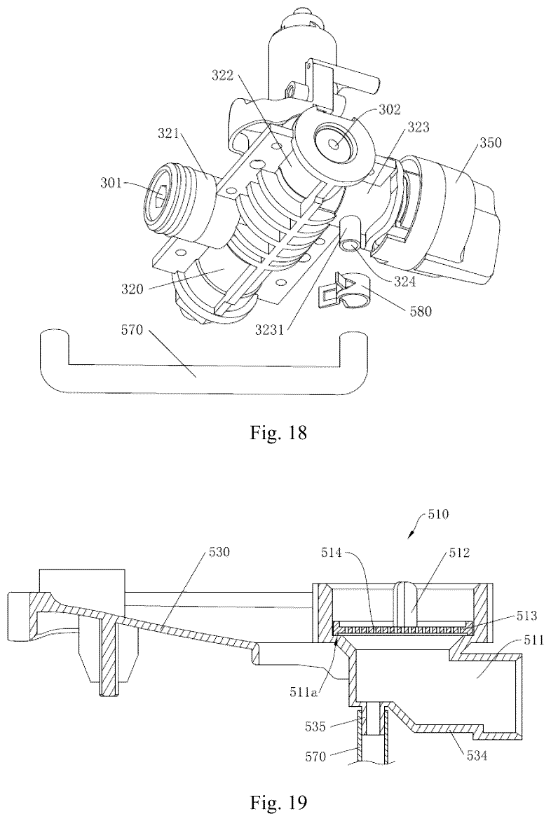

Referring to FIGS. 17, 18, and 19, in this implementation, the return line 570 is disposed on the base 500, one end of the return line 570 communicating with the drainage port 324, another end thereof communicating with the communication structure 510, so that the coating material flowing out from the drainage port 324 flows back into the communication structure 510 via the return line 570. Specifically, the pressure relief line 323 is provided with a first hollow column 3231 protruding outward surrounding the drainage port 324, and a third hollow column 535 protruding outward is provided on the tubular shell 534, holes on the third hollow column 535 communicating with the communication passage 511; the return line 570 is disposed at a bottom portion of the base 500, one end of the return line 570 being fixedly sleeved on the first hollow column 3231 via a clamp 580, another end thereof being fixedly sleeved on the third hollow column 535. When the hydraulic pressure in the pump chamber reaches the pressure relief predetermined value so that the pressure relief valve is opened to release pressure, the coating material flowing out from the drainage port 324 flows back into the communication passage 511 of the communication structure 510 via the return line 570.

In this implementation, since the return line 570 is disposed on the base 500, with one end thereof being fitted with the pump body 320 and another end thereof being fitted with the communication structure 510, the return line 570 is not fitted with the tank 100, which may eliminate a hinderance to assembly and disassembly of the tank 100, i.e., the return line 570 is not a bother to the user when mounting the tank 100 on the base 500 or removing the tank 100 from the base 500, which facilitates enhancing user experience of the user.

The other contents of the third implementation are identical to the first implementation, which are not detailed here.

In addition to the example implementations described supra, the present disclosure also has other implementations. Those skilled in the art may make various modifications and alterations to the present disclosure, and all of such modifications and alterations without departing from the spirits of the present disclosure shall fall into the scope defined in the appended claims of the present disclosure.

I/We claim:

1. A spray coating apparatus, comprising:
a tank in which a coating material is held;
a spray gun which atomizes and sprays out the coating material pressurized;
and a pump which pressurizes and pumps the coating material from the tank to the spray gun, the pump having an inlet and an outlet;
wherein the spray coating apparatus further comprises a base on which the tank is detachably mounted, the pump being disposed in the base, a switching valve being provided at an underside of the tank; a communication structure operable to communicate the switching valve with the inlet is provided on the base; the tank, when being mounted on the base, actuates the switching valve to switch from a closed state to an open state, and when being detached from the base, actuates the switching valve to switch from the open state to the closed state.

2. The spray coating apparatus according to claim 1, wherein the switching valve comprises a valve seat, a valve disk, and an elastic member, a valve bore being set on the valve seat, the valve disk being movably disposed on the valve seat and operable to open and close the valve bore, the elastic member biasing the valve disk in a direction of closing the valve bore.

3. The spray coating apparatus according to claim 2, wherein the communication structure comprises a communication passage in which an ejector rod corresponding to the switching valve is provided; and the tank, when being mounted on the base, drives the valve disk to engage the ejector rod so that the valve disk overcomes a bias imposed by the elastic member to open the valve bore.

4. The spray coating apparatus according to claim 3, wherein a filter mounted detachably is provided in the communication passage, a plurality of filter holes distributed at even intervals being set on the filter, the ejector rod being disposed on the filter.

5. The spray coating apparatus according to claim 1, wherein the switching valve is disposed on a bottom wall of the tank, the bottom wall of the tank extending obliquely downward from a position distant from the switching valve toward a position where the switching valve is located.

6. The spray coating apparatus according to claim 5, wherein a local top wall of the base under the tank extends obliquely downward from a position distant from the communication structure to a position where the communication structure is located, a slope of the local top wall of the base being greater than a slope of the bottom wall of the tank.

7. The spray coating apparatus according to claim 1, wherein the underside of the tank is provided with a support leg protruding downward, an underside of the support leg being lower than an underside of the switching valve, a locating hole for the support leg to insert being provided on the base; and/or, a locking fastener for securing the tank is provided on the base, and a catch block or catch recess fitted with the locking fastener is provided on the tank.

8. The spray coating apparatus according to claim 1, wherein the pump comprises an electric motor, a pump body, and a transmission structure, the pump body being transversely rested in the base, a central axis of the pump body being disposed lower than the bottom wall of the tank.

9. The spray coating apparatus according to claim 1, wherein the base comprises a bottom casing, a top casing, and a cover, the top casing and the cover being secured side by side on the bottom casing, the tank being detachably mounted on top of the top casing, the cover and the bottom casing being fitted to define a mounting cavity in which the pump is disposed.

10. The spray coating apparatus according to claim 9, wherein the cover has a storage cavity downwardly recessed.

11. The spray coating apparatus according to claim 1, wherein the pump is further provided with a drainage port, a return line being attached at the drainage port; and the return line drains the coating material flowing out via the drainage port into the tank or the communication structure.

12. The spray coating apparatus according to claim 11, wherein the return line drains the coating material flowing out from the drainage port into the tank, one end of the return line communicating with the drainage port, another end of the return line being provided with a first return connector, the first return connector being fixedly secured on the base or detachably secured on the base; a second return connector detachably fitted with the first return connector is provided on the tank;
the tank, when being mounted on the base, drives the second return connector to be plug-fitted with the first return connector, whereby the another end of the return line communicates with an inside of the tank; and
the tank, when being detached from the base, drives the second return connector to be separated from the first return connector.

13. The spray coating apparatus according to claim 11, wherein the return line drains the coating material flowing out from the drainage port into the communication structure, the return line being disposed on the base, one end of the return line communicating with the drainage port, another end of the return line communicating with the communication structure.
